(19) United States
(12) Patent Application Publication
(10) Pub. No.: US 2025/0187527 A1
(43) Pub. Date: Jun. 12, 2025

(54) Tensioning Tool for Load Restraint Strips and Method of Use

(71) Applicant: MBull Holdings, LLC, North Miami Beach, FL (US)

(72) Inventor: Matthew Bullock, McLean, VA (US)

(21) Appl. No.: 18/533,865

(22) Filed: Dec. 8, 2023

(51) Int. Cl. B60P 7/08

(52) U.S. Cl. CPC B60P 7/0853; B60P 7/083

(57) ABSTRACT

A tensioning tool usable with load restraint strips may comprise a winding fork, a wrench, and a reaction bar. The reaction bar may comprise a reaction bar head that is switchable between two alternate configurations. In a first configuration, a hub in the reaction bar head may ratcheted and only rotatable within the head in one of two rotational directions. In a second configuration, the hub may be free-turning and rotatable in both rotational directions.

### BACKGROUND

Intermodal containers are commonly used when shipping goods domestically and/or internationally. Such containers can be loaded onto cargo ships for transport across oceans or other bodies of water. For land transport, these containers can be placed onto a trailer and then hauled overland by truck. Such containers can also be loaded onto railroad flatcars for transport.

Shipping containers can be loaded with numerous forms of cargo. Applicable regulations require that such cargo be restrained from lateral shifting, as a shipping container may experience significant movement as the container is carried by ocean vessel or by other conveyance. If cargo is not restrained, it may shift and collide with a container wall or container doors. Because the mass of cargo in a container can be significant, such shifting and/or collisions can have catastrophic consequences.

Load restraint strips can be used to secure cargo within a shipping container. Each load restraint strip may be flexible and have an adhesive coated end that is pressed into contact with an interior side wall of the container. The other ends of the load restraint strips may then be wrapped around cargo and tightened. The wrapped ends may be tightened using a tool and method such as are described in U.S. Pat. No. 6,981,827, which patent is incorporated by reference herein. An adhesive-backed patch may then be applied over the tightened ends to secure those ends together. This procedure may be repeated numerous times inside a single shipping container.

After tightening load restraint strips, and after application of an adhesive-backed patch to secure the ends of those load restraint strips, the tightening tool must be removed. However, the removal process for existing tools can be cumbersome and time consuming, and/or may require two workers. This may cause increased labor costs and/or delays associated with loading shipping containers. Moreover, existing adhesive-backed patches used to secure ends of tightened load restraint strips may provide an incomplete solution.

### SUMMARY

This Summary is provided to introduce a selection of some concepts in a simplified form as a prelude to the Detailed Description. This Summary is not intended to identify key or essential features.

A tensioning tool usable with load restraint strips may comprise a winding fork, a wrench, and a reaction bar. To facilitate removal of the reaction bar from the winding fork after tensioning of load restraint strips, and after the tensioned load restraint strips have been secured by attaching an adhesive backed patch, the reaction bar may comprise a reaction bar head that is switchable between two alternate configurations. In a first configuration, a hub in the reaction bar head may ratcheted and only rotatable within the head in one of two rotational directions. In a second configuration, the hub may be free-turning and rotatable in both rotational directions.

An adhesive-backed patch may be configured for securing tensioned ends of load restraint strips. The patch may have a width that is greater than the load restraint strips, with lateral regions of the patch usable for attachment to cargo secured by the load restraint strips.

These and other features are described in more detail below.

### BRIEF DESCRIPTION OF THE DRAWINGS

Some features are shown by way of example, and not by way of limitation, in the figures of the accompanying drawings and in which like reference numerals refer to similar elements.

FIG. 1A shows an example tensioning tool for use in securing load restraint strips.

FIG. 1B is an enlarged, partially schematic cross-sectional view taken from the location indicated in FIG. 1B

FIG. 2A shows an example of placing a winding fork, of the tensioning tool of FIG. 1A, onto load restraint strips.

FIG. 2B shows the winding fork of FIG. 2A after placement onto the load restraint strips.

FIG. 2C shows an example of installing a wrench, of the tensioning tool of FIG. 1A, onto the winding fork shown in FIG. 2B.

FIG. 2D shows an example of installing a reaction bar, of the tensioning tool of FIG. 1A, onto the winding fork, shown in FIG. 2C, after installation of the wrench.

FIGS. 2E, 2F, 2G, and 2H show examples of operations during tensioning of the load restraint strips using the winding fork, the installed wrench, and the installed reaction bar.

FIG. 2I shows the load restraint strips of the example of FIG. 2A after tensioning.

FIG. 2J shows the tensioned load restraint strips of FIG. 2I after attachment of an adhesive-backed patch.

FIGS. 2K, 2L, and 2M show examples of operations during removal of the reaction bar, the wrench, and the winding fork.

FIGS. 3A, 3B, and 3C are respective top, bottom and side views of the reaction bar of the tensioning tool of FIG. 1A.

FIGS. 3D and 3E are respective top and side views of a frame of the reaction bar of the tensioning tool of FIG. 1A.

FIGS. 3F and 3G partially schematic cross-sectional views, from the location indicated in FIG. 3C, of a reaction bar head of the reaction bar of the tensioning tool of FIG. 1A.

FIG. 3H is a partially schematic area cross-sectional view, from the location indicated in FIG. 3C, of the reaction bar head of the reaction bar of the tensioning tool of FIG. 1A.

FIGS. 4A and 4B are respective top and side view of the wrench of the tensioning tool of FIG. 1A.

FIG. 4C is an exploded view of a portion of the components of the wrench of the tensioning tool of FIG. 1A.

FIGS. 5A, 5B, and 5C show additional examples of tensioning tools for use in securing load restraint strips.

FIG. 6A shows a first side of an example patch.

FIG. 6B shows a second side of the patch of FIG. 6A.

FIGS. 6C and 6D show an example use of the patch of FIGS. 6A and 6B.

FIG. 6E is a partially schematic cross-sectional view from the location indicated in FIG. 6B.

FIG. 6F shows another example use of the patch of FIGS. 5A and 5B.

FIG. 7A shows a first side of another example patch.

FIG. 7B shows a second side of the patch of FIG. 7A.

FIGS. 7C and 7D show an example use of the patch of FIGS. 7A and 7B.

FIG. 8A shows a first side of another example patch.

FIG. 8B shows a second side of the patch of FIG. 8A.

FIGS. 8C and 8D show an example use of the patch of FIGS. 8A and 8B.

### DETAILED DESCRIPTION

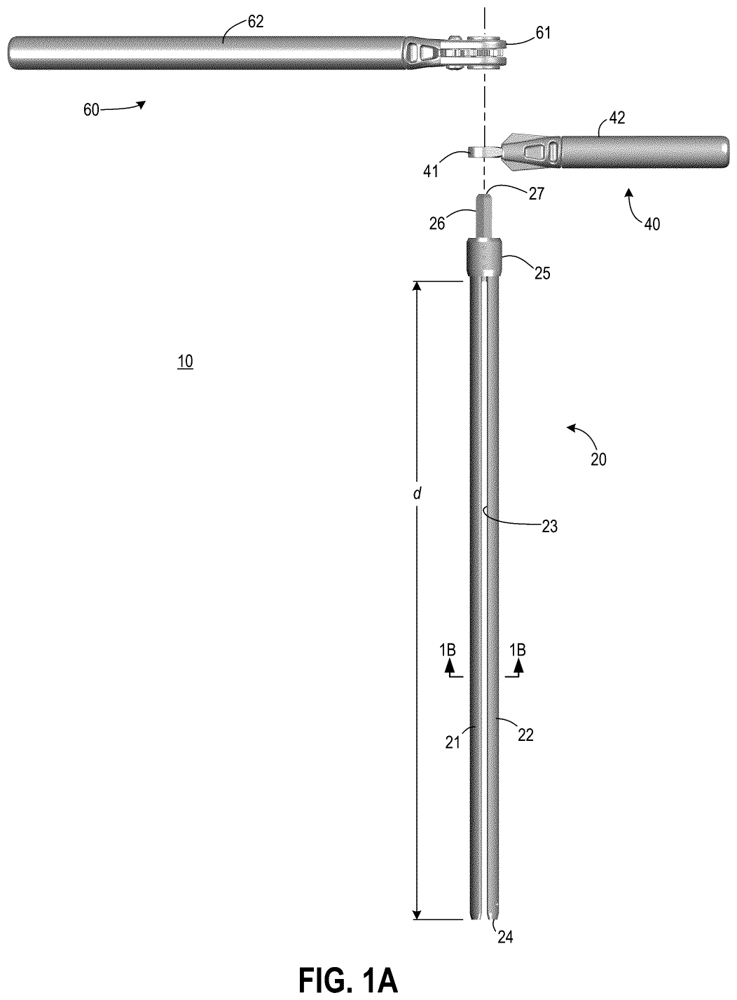

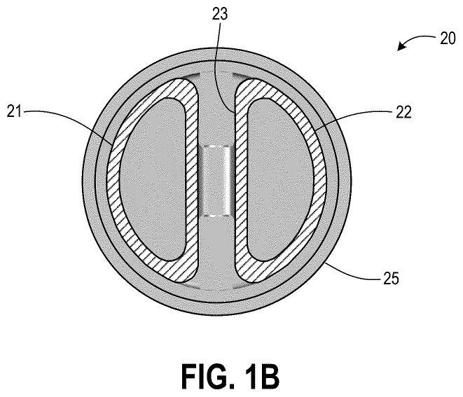

FIG. 1A shows, in a disassembled configuration, a tensioning tool 10 that may be used for securing load restraint strips. The tensioning tool 10 comprises a winding fork 20, a wrench 40, and a reaction bar 60.

The winding fork 20 comprises a pair of tines 21 and 22 that are defined by a slot 23 that extends upward in a longitudinal direction from a lower end 24 of the winding fork 20. The slot 23 may be sized so that the tines 21 and 22 have a length sufficient to extend across an entire width of an overlapped pair of load restraint strips, as described in further detail below. The slot may have a depth d of at least 24 inches, 30 inches, 36 inches, or more. The tines 21 and 22 join, and are fixed relative to, a thickened region 25. A post 26 extends upward from, and is fixed relative to, the thickened region 25 and terminates at an upper end 27. The post 26 may, in a cross-sectional plane perpendicular to the longitudinal direction of the winding fork 20 (e.g., perpendicular to the direction indicated by the uneven broken line shown in FIG. 1A), have a cross-sectional shape (e.g., hexagonal) that comprises corners to facilitate gripping the post 26 by the wrench 40 and by the reaction bar 60.

FIG. 1B is an enlarged, partially schematic cross-sectional view taken from the location indicated in FIG. 1A. The portion of the winding fork 20 comprising the tines 21 and 22 may be formed from extruded aluminum, and the tines 21 and 22 may be hollow to reduce weight. End caps may be inserted into open ends of the tines 21 and 22 at the lower end 24. Other portions of the winding fork 20 may also be formed from aluminum and/or from other materials. For example, the post 26 may be formed from steel, titanium, or other material.

The wrench 40 may comprise a ratcheting box end wrench head 41 and a wrench shaft 42. An opening in the wrench head 41 may be sized so that the post 26 may, as indicated by the uneven broken line in FIG. 1A and as part of assembling the tensioning tool 10, be inserted through the opening. The wrench head opening may comprise a profile that is configured to grip and transfer torque to an object (e.g., the post 26) that has been inserted into the wrench head opening. Additional features of the wrench 40 are described below.

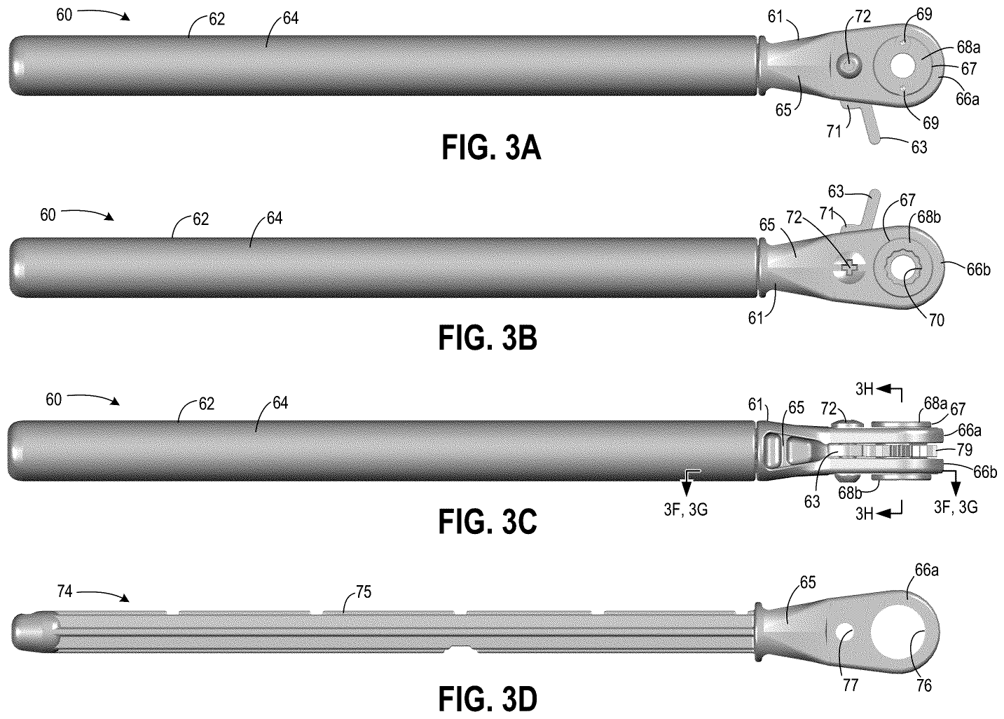

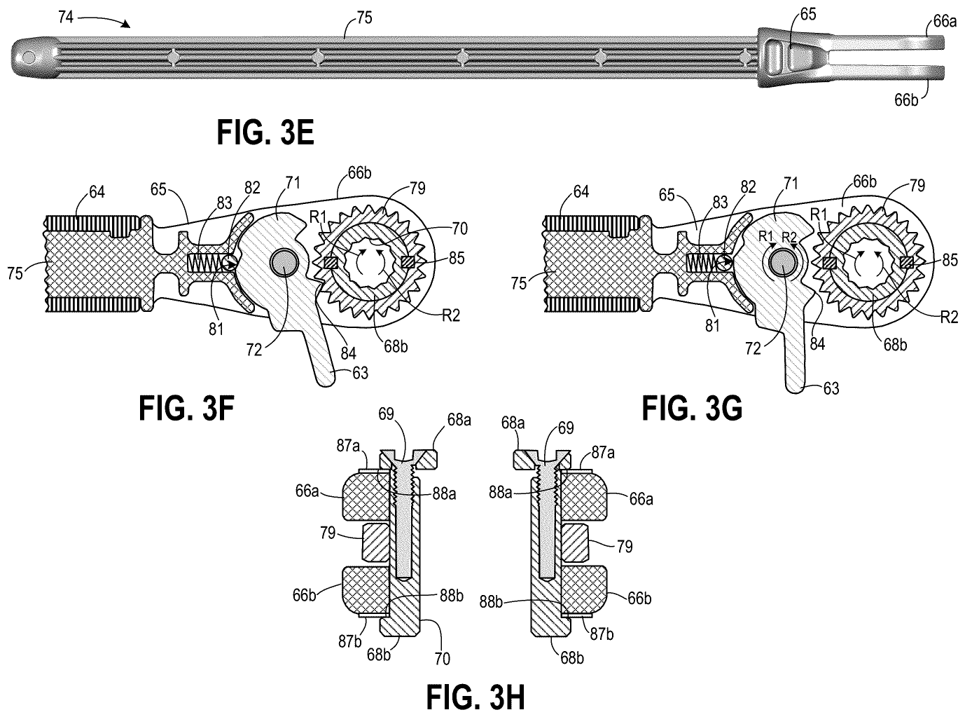

The reaction bar 60 may comprise a reaction bar head 61 and a reaction bar shaft 62. The head 61 may comprise a hub, described more fully in connection with FIGS. 3A-3H, that is rotatable within the head 61. The head 61 may be alternately configurable to operate in a ratcheted condition (e.g., with the hub only rotatable in only one of two rotational directions within the head 61) or free-turning (e.g., rotatable in either of two rotational directions within the head 61). An opening in the hub may also be sized so that the post 26 may, as indicated by the uneven broken line in FIG. 1A and as part of assembling the tensioning tool 10, be inserted through the opening. The hub opening may comprise a profile that is configured to grip and transfer torque to an object (e.g., the post 26) that has been inserted into the hub opening. Additional details of the reaction bar 60 are described below.

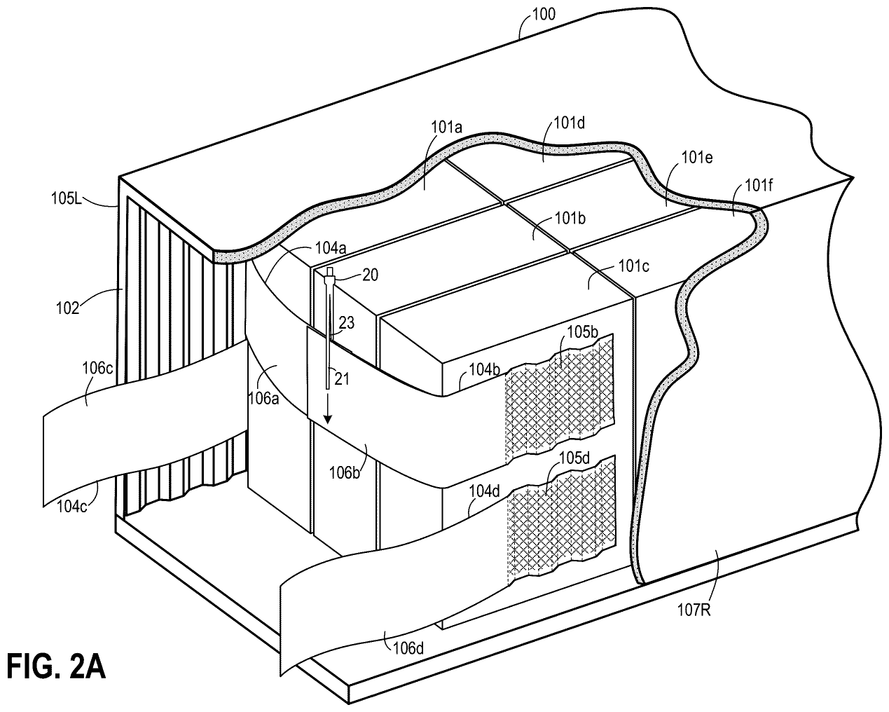

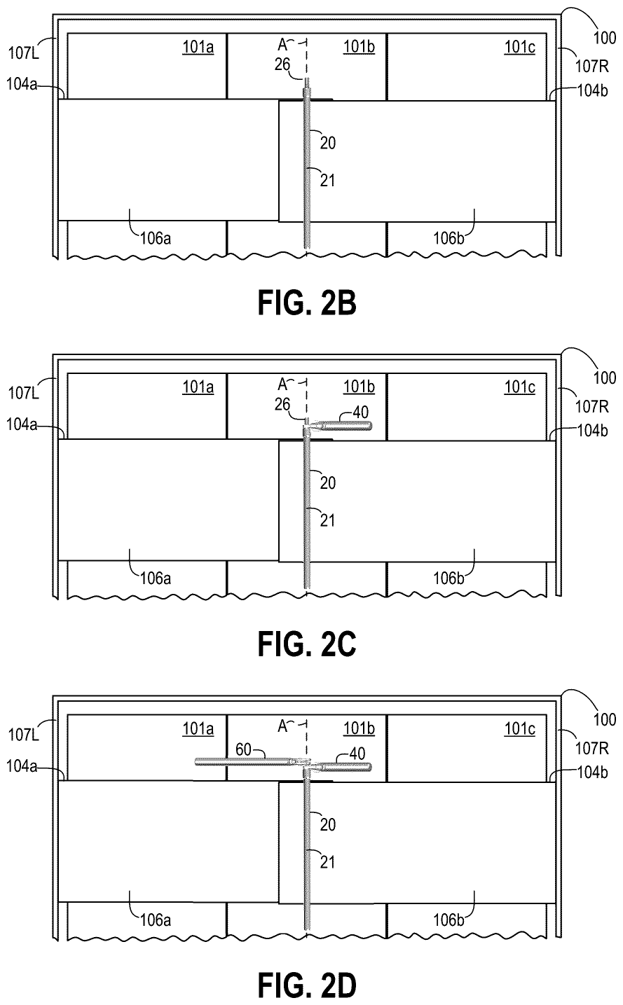

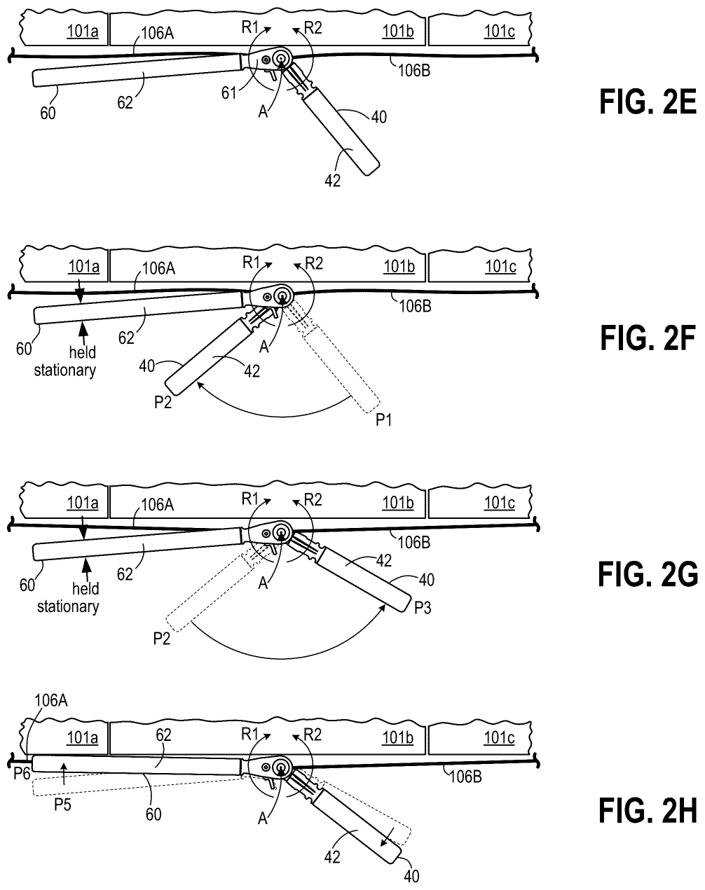

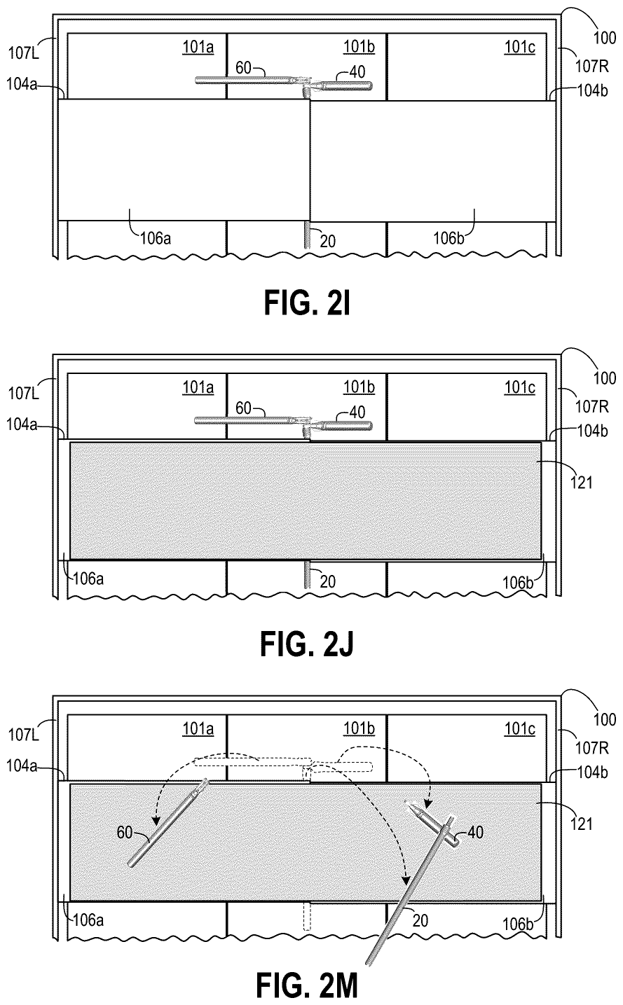

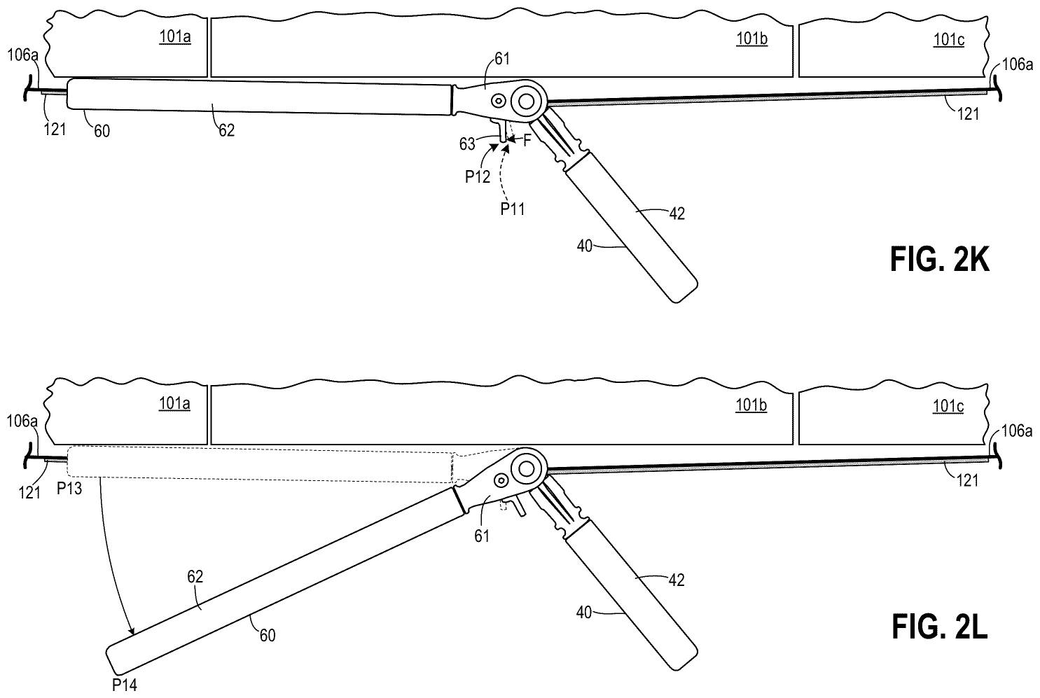

FIG. 2A shows an example of placing the winding fork 20, of the tensioning tool 10, onto load restraint strips. In particular, FIG. 2A shows a portion of a cargo container 100. In the example of FIG. 2A, the cargo container 100 may comprise a shipping container. Also or alternatively, the tensioning tool 10 and other elements described herein may be used with load restraint strips in another type of cargo container (e.g., a semi trailer, a rail car, or any other type of container used to hold cargo during transport). A rear end 102 of the cargo container 100 may comprise doors (not shown) used to close the cargo container 100. A front end of the cargo container 100 is omitted from FIG. 2A, and portions of a top and of a right side wall of the cargo container 100 have been omitted to show interior details.

As further shown in FIG. 2A, cargo units 101a, 101b, 101c, 101d, 101e, and 101f have been loaded in the cargo container 100. Also shown are four load restraint strips 104a, 104b, 104c, and 104d (collectively referred to load restraint strips 104; generically referred to as load restraint strip 104). The load restraint strips 104 may all have a similar structure. Each load restraint strip 104 may comprise a base layer, a reinforcing layer fixed to the base layer, and an adhesive layer in an attachment region of the load restraint strip. Each of load restraint strips 104 may, for example, have a structure such as that described in any of U.S. Pat. Nos. 6,089,802, 6,227,779, 6,607,337, 6,896,459, 6,923,609, 7,018,151, 7,066,698, 7,290,969, 7,329,074, 8,113,752, 8,128,324, 8,403,607, 8,403,608, 8,403,609, 8,408,852, 8,419,329, 8,979,449, 9,090,194, 10,654,399, and/or U.S. patent application Ser. No. 18/195,583. All of those patents and the patent application, in their entireties, are incorporated by reference herein. Additional examples of load restraint strips include, without limitation, load restraint strips sold under the name Ty-Gard 2000® and load restraint strips sold under the name Ty-Gard DS™ by Walnut Industries, Inc. of Bensalem, PA, US. The base layer, which may extend the entire length and width of a load restraint strip 104, may for example, comprise a non-woven spun-bonded material, a stitch-bonded material, or other type of material. The reinforcing layer, which may also extend the entire length and width of a load restraint strip 104, may, for example, comprise strands of reinforcing material (e.g., polyester fibers) that extend lengthwise along the load restraint strip 104. An adhesive layer may, for example, comprise a layer of adhesive applied to an attachment region located at one end of a load restraint strip 104.

Prior to loading of the cargo units 101a-101c, the adhesive 105b in the attachment region of the load restraint strip 104b, and the adhesive 105d in the attachment region of the load restraint strip 104d, were pressed into contact with the interior of the right side wall 107R of the cargo container 102, thereby attaching the load restraint strips 104b and 104d to the wall 107R. Similarly, the adhesive in the attachment region of the load restraint strip 104a, and the adhesive in the attachment region of the load restraint strip 104c, were pressed into contact with the interior of the left side wall 107L of the cargo container 102, thereby attaching the load restraint strips 104a and 104c to the wall 107L. Respective tails 106a-106d of the load restraint strips 104a-104d were subsequently extended rearwardly (e.g., by temporarily taping the tails 106a-106d to the interior sides of the walls 107L and 107R) and the cargo units 101a-101c loaded into place. After loading the cargo units 101a-101c, the tails 106a and 106b of the load restraint strips 104a and 104b were wrapped around the rear of the cargo units 101a-101c. As shown in FIG. 2A, the winding fork 20 may be placed onto overlapped portions of the tails 106a and 106b by sliding the winding fork 20 downward to position those overlapped portions in the slot 23.

FIG. 2B is a rear view of a portion of the cargo container 100 showing the position of the winding fork 20, relative to the tails 106a and 106b of the load restraint strips 104a and 1014b, after completing the placement of the winding fork 20. Tine 21 is on a rear side of the overlapped portions of the tails 106a and 106b, and the tine 22 (not visible in FIG. 2A) is between a front side of those overlapped portions and a rear face of the cargo unit 101b. The tines 21 and 22 extend beyond lower edges of the tails 106a and 106b. A longitudinal axis A of the winding fork 20 passes through a center of the winding fork 20 and is parallel to a lengthwise direction of the winding fork 20.

FIG. 2C is a rear view of the portion of the cargo container 100 showing the tensioning tool 10 partially assembled, and in particular, showing the wrench 40 installed on the winding fork 20. To install the wrench 40 onto the winding fork 20, the wrench 40 was positioned with the opening in the wrench head 41 aligned with the post 26. The wrench 40 was then moved downward so that the post 26 extends through the wrench head opening.

FIG. 2D is a rear view of the portion of the cargo container 100 showing the tensioning tool 10 fully assembled, and in particular, showing the reaction bar 60 installed on the winding fork 20 over the wrench 40. To install the reaction bar 60 onto the winding fork 20, the reaction bar 60 was positioned with the opening in the hub of the reaction bar head 61 aligned with the post 26. The reaction bar 60 was then moved downward so that the post 26 extends through the hub opening.

FIGS. 2E, 2F, 2G, and 2H show examples of operations during tensioning of the load restraint strips 104a and 104b using the tensioning tool 10. Each of FIGS. 2E-2H is a view looking down on the top of the reaction bar 60, which has been installed on the winding fork 20 over the wrench 40, and on the top of the wrench 40. The winding fork 20 is not visible in FIGS. 2E-2H, but a location of the longitudinal axis A of the winding fork 20 is indicated. Portions of the cargo units 101a-101c, of the tail 106a of the load restraint strip 104a, and of the tail 106b of the load restraint strip 104b are also shown in each of FIGS. 2E-2H.

The ratcheting wrench head 41 of the wrench 40 may be configured so that, when the post 26 of the winding fork 20 is inserted into the wrench head opening of the wrench head 41, the wrench shaft 42 is rotatable, relative to the post 26 and about the axis A, in a first rotational direction R1, but is not rotatable, relative to the post 26 and about the axis A, in a second rotational direction R2 that is opposite the first rotational direction R1. This corresponds to the post 26 (and the winding fork 20) being rotatable, relative to the wrench head 41 and about the axis A, in the second rotational direction R2 but not rotatable, relative to the wrench head 41 and about the axis A, in the first rotational direction R1. Thus, when the wrench 40 is installed on the winding fork 20, rotating the wrench shaft 42 about the axis A in the second rotational direction R2 also rotates the winding fork 20 in the second rotational direction R2.

Moreover, and as explained in more detail below, the reaction bar 60 may be alternately configurable in a first or second configuration. In the first configuration, a hub in the reaction bar head 61 may be ratcheted. In that first configuration, when the post 26 of the winding fork 20 is inserted into an opening of the hub, the reaction bar shaft 62 may be rotatable, relative to the post 26 and about the axis A, in the first rotational direction R1 but not rotatable, relative to the post 26 and about the axis A, in the second rotational direction R2. This corresponds to the post 26 (and the winding fork 20) being rotatable, relative to the reaction bar head 61 and about the axis A, in the second rotational direction R2 but not rotatable, relative to the reaction bar head 61 and about the axis A, in the first rotational direction R1. Thus, when the reaction bar 60 is installed on the winding fork 20, holding the reaction bar shaft 62 stationary allows the post 26 (and the winding fork 20) to rotate about the axis A in the second rotational direction R2 but prevents the post 26 (and the winding fork 20) from rotating about the axis A in the first rotational direction R1.

In the example the tensioning tool 10, and in a view (such as that of FIGS. 2E-2H) looking down on the top of the wrench 40 and the top of the reaction bar 60, the first rotational direction R1 is clockwise and the second rotational direction R2 is counterclockwise. However, a wrench and a reaction bar could alternately be constructed so that, in a view similar to that of FIGS. 2E-2H, the first rotational direction R1 is counterclockwise and the second rotational direction R2 is clockwise.

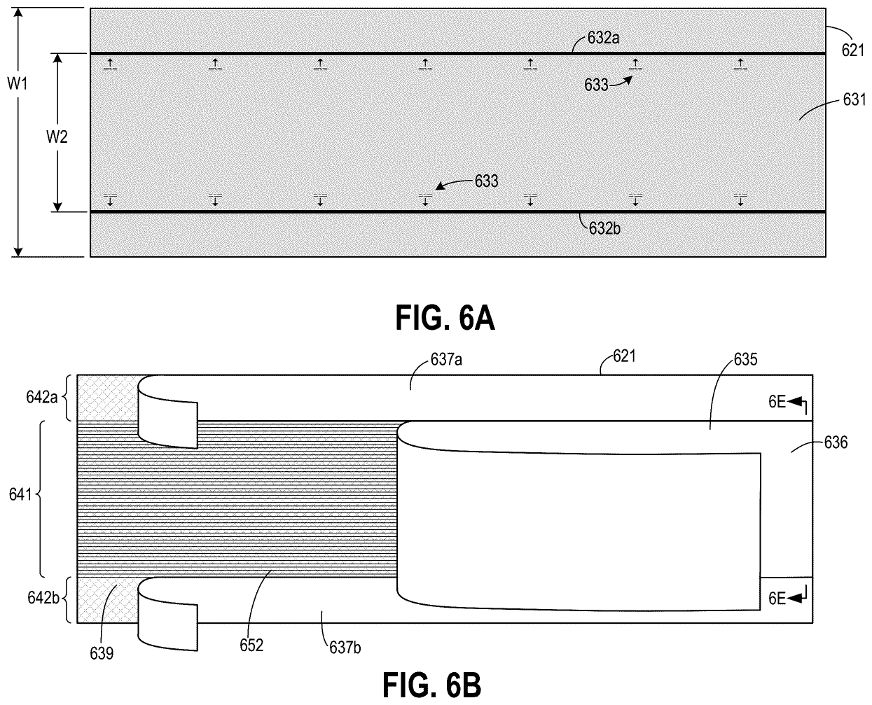

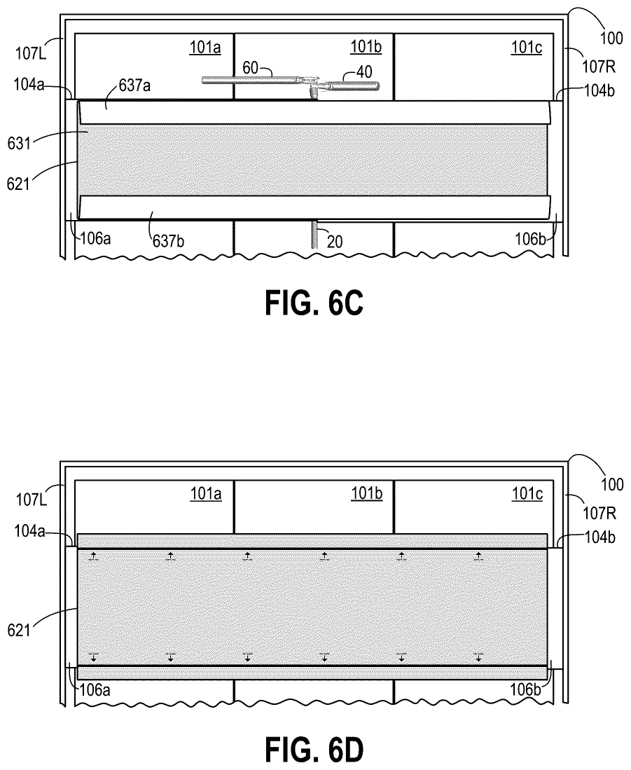

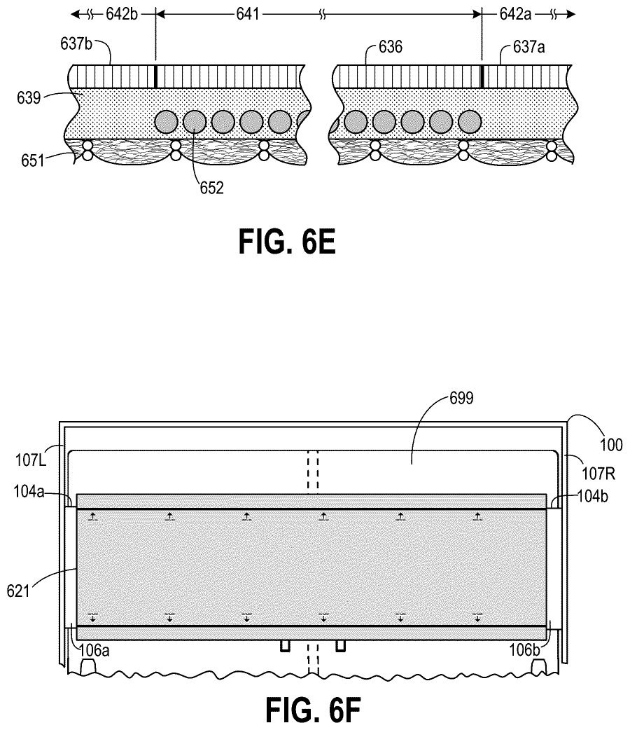

In FIG. 2E, the tails 106a and 106b of the load restraint strips 104a and 104b may still be somewhat slack. For example, the winding fork 20 may not have been rotated about axis A or may only have been partially rotated about axis A. In FIG. 2F, the wrench shaft 42 is rotated clockwise (R1) about the axis A, from a position P1 to a position P2, in preparation for applying tension to the tails 106a and 106b. Because of the configuration of the ratcheted wrench head 41, no significant torque is imparted on the winding fork 20 during the movement of the wrench shaft 42 from position P1 to position P2 and the winding fork 20 does not rotate about the axis A. The reaction bar shaft 62 is held stationary, thus preventing the winding fork 20 from rotating clockwise (R1) about the axis A, and also holding the shaft 62 in position for the next step shown in FIG. 2G. In FIG. 2G, and while the reaction bar shaft 62 is still held stationary, the wrench shaft 42 is rotated counterclockwise (R2) from position P2 to position P3. This rotates the winding fork counterclockwise (R2) about the axis A and winds the overlapped ends of the tails 106a and 106b around the tines 21 and 22, thereby tensioning the tails 106a and 106b. The steps of FIGS. 2F and 2G may be repeated until the desired amount of tension is imparted to the tails 106a and 106b. After the desired amount of tension is imparted, the shafts 42 and 62 may be released. Tension in the tails 106a and 106b causes the winding fork to rotate clockwise (R1) until the loaded cargo prevents further motion (e.g., until further clockwise rotation of the reaction bar shaft 62 is stopped when the reaction bar shaft 62 contacts a rear face of the cargo unit 101a in the example of FIG. 2G). In other examples (e.g., if a bulkhead is present, as described in connection with FIG. 6E), the loaded cargo may prevent further motion without the reaction bar shaft 62 actually touching loaded cargo.

FIG. 2I is a rear view of the portion of the cargo container at the conclusion of the step shown in FIG. 2G. The tails 104a and 104b are tensioned, but that tension is only maintained because reaction bar shaft 62 rests against the loaded cargo and prevents the winding fork from rotating clockwise (R1) to unwind the tails 106a and 106b from the winding fork 20. Accordingly, and as shown in FIG. 2J a patch 121 is attached to the tails 106a and 106b. The patch 121 may comprise a backing material and reinforcement strands that extend in a lengthwise direction (horizontal, in the example of FIG. 2J), as well as an adhesive on one face of the patch 121. To attach the patch 121, that adhesive is exposed (e.g., by removing a release liner) and the adhesive is pressed into contact with the tails 106a and 106b. The patch 121 may, for example, comprise a patch such as that sold under the name Ty-Patch® by Walnut Industries, Inc.

After attaching the patch 121, the tensioning tool 10 may be removed. With previously-available tensioning tools, removal of such tools after patch application could sometimes pose difficulties. In order to remove a reaction bar from a winding fork that is holding tensioned load restraint strip tails, the reaction bar must be moved away from the cargo against which it is resting. Although some previously-existing tools comprised a mechanism to release a ratchet in a reaction bar, that mechanism required a worker to apply continuous pressure to a keep the ratchet released, and the release mechanism may sometimes have been difficult to access (e.g., by a worker wearing gloves). As a result, removal of previously-available tools would sometimes require moving the reaction bar in a direction that would impart additional tension to the load restraint strip tails. But moving the reaction bar far enough to permit removal may require imparting excessive tension that may damage cargo, the load restraint strips, or the attached patch. Moreover, such an operation may require two workers, as it may be difficult for a single worker to rotate the reaction bar shaft, to hold the wrench (in order to remove rotational stress on the reaction bar head), and to remove the reaction bar head from the winding fork.

To address these problems, and as indicated above, the reaction bar 60 may be alternately configurable in a first or second configuration using an easily-manipulatable extension. In a first configuration, which may be selected when using the reaction bar 60 for the steps shown in FIGS. 2E-2J, a hub in the reaction bar head 61 may be ratcheted. In the second configuration, which may be selected when removing the tensioning tool 10 from tensioned load restraint strips after attaching a patch, the hub in the reaction bar head 61 may be free-turning.

Selection of the second configuration is shown in FIG. 2K, which is a view looking down on the top of the reaction bar 60 and the wrench 40 of the tensioning tool 10, the winding fork 10 of which is held in the tensioned tails 106a and 106b secured by the attached patch 121. The reaction bar head 61 comprises an extension 63 that protrudes from a side of the head 61. The extension 63 may be moved from a first position P1 (corresponding to the first configuration) to a second position (corresponding to the second configuration) by application of a force F. After moving the extension 63 from position P1 to P2, the reaction bar 60 remains in the second configuration after discontinuing application of the force F. After switching to the second configuration from the first configuration, the reaction bar shaft 62 may be freely rotated, as shown in FIG. 2L, away from a position P13 against the secured cargo and into a position P14 to allow removal from the post 26 of the winding fork 20. Subsequently, and as indicated in the rear view of FIG. 2M, the reaction bar 60 and the wrench 40 may be removed from the post 26 of the winding fork 20, and the winding fork 20 may be removed from the tensioned and patched tails 106a and 106b. Tails 106c and 106d may be tensioned and patched (and the tensioning tool 10 removed after such tensioning and patching) in a manner similar to that in which the tails 106a and 106b tensioned and patched.

FIGS. 3A-3H show additional details of the reaction bar 60. FIG. 3A is a top view of the reaction bar 60. FIG. 3B is a bottom view of the reaction bar 60. FIG. 3C is a side view of the reaction bar 60. The shaft 62 of the reaction bar 60 comprises an overmolded plastic outer portion 64 and an inner portion described below. The shaft 62 may be cylindrical (e.g., may have a circular outer shape in a plane perpendicular to the lengthwise direction of the reaction bar). The reaction bar head 61 comprises a main body 65, with the main body 65 further comprising an upper plate 66a and a lower plate 66b. The head 61 further comprises a hub 67 that is rotatable within openings in the plates 66a and 66b, with the hub 67 further comprising an upper ring 68a that is secured, by threaded fasteners 69, to a lower hub portion 68b. An opening 70 in the lower hub portion 68b may be sized to receive the post 26 of the winding fork 20 and may have a profile that comprises a series of features configured to prevent the post 26, once inserted into the opening 70, from rotating within the opening 70 or relative to the hub 67. The reaction bar head 61 further comprises an arm 71, described in more detail below, of which the extension 63 is a part. A fastener 72 secures the arm between the plates 66a and 66b and provides a pivot about which the arm 71 may rotate. Also partially visible in FIG. 3C is a gear 79, further described below, that is part of the hub 67.

FIG. 3D is a top view of a frame 74 of the reaction bar 60. FIG. 3E is a side view of the frame 74. The frame 74 may be a monolithic single element formed from aluminum, steel, and/or or other suitable material. The frame 74 comprises the head main body 65 and an inner shaft portion 75 about which the plastic outer portion 64 is molded. A first hole 76 extends through the upper plate 66a and the lower plate 66b. The hub 67 rotates within the first hole 76. A second hole 77 extends through the upper plate 66a and the lower plate 66b and receives the fastener 72.

FIG. 3F is a partially schematic cross-sectional view of the reaction bar head 61 taken from the location indicated in FIG. 3C. In FIG. 3F, the head 61 is in the first configuration described above, and in particular, configured so that the hub 67 is ratcheted and only rotatable within the head 61 in one rotational direction. In FIG. 3F, the lower portion 68b and the gear 79 are visible. The gear 79 may be fixed relative to the lower portion 68b by one or more keys 85, and/or by otherwise fixing the gear 79 relative to the lower portion 68b. For example, the lower portion 68b may have a non-circular outer shape in a middle region and that may fit within a corresponding non-circular aperture of the gear 79. The arm 71 comprises a pawl 84 that, in the first configuration, contacts the gear 79. If the hub 67 and rotates in the second rotational direction R2 relative to the main body 65 (counterclockwise in FIG. 3F), the action of the teeth of the gear 79 against the pawl 84 will cause the arm 71 to rotate about the fastener 72 in the first rotational direction R1 (clockwise in FIG. 3F) and allow the gear hub 67 to continue rotating. Conversely, if the hub 67 attempts to rotate in the first rotational direction R1 relative to the main body 65, the teeth of the gear 79 are blocked by the pawl 84, and because of the shape of the teeth and the pawl 84, the arm 71 does not rotate about the fastener 72. As a result, rotation of the hub 67 within the main body 65 in the first rotational direction R1 is prevented. The head 61 further comprises a contact member 82 (e.g., a ball bearing) that biased by a spring 83 against a cam surface 81 formed on an edge of the arm 71. In the first configuration, the biasing force of the contact member 82 against a first portion of the cam surface 81 pushes the pawl 84 against the gear 79.

FIG. 3G is a partially schematic cross-sectional view of the reaction bar head 61 taken from the location indicated in FIG. 3C. In FIG. 3G, the head 61 is in the second configuration described above, and in particular, configured so that the hub 67 is free to rotate within the main body 65 in the first rotational direction R1 and also free to rotate within the main body 65 in the second rotational direction R2. In the second configuration, the contact member 82 is biased against a second portion of the cam surface 81 and holds the arm 71 (without requiring continuous pressure by a user on the extension 63) in a position in which the gear 79 may rotate without gear teeth contacting the pawl 84. As can be appreciated from FIGS. 3F and 3G and the previous description, the head 61 may be switched from the first configuration to the second configuration by pushing on the extension 63 to rotate the arm 71 about the fastener 72 in the first rotational direction R1. Similarly, the head 61 can be switched from the second configuration to the first configuration by pushing on the extension 63 to rotate the arm 71 about the fastener 72 in the second rotational direction R2.

FIG. 3H is a partially schematic area cross-sectional view from the location indicated in FIG. 3C and shows additional details of the hub 67 and its mounting in the main body 65. The lower portion 68b includes a lip 88b that rests against a bearing ring 87b (e.g., a polymer material) resting between the lip 88b and the bottom surface of the lower plate 66b. The upper ring 68a includes a lip 88a that rests against a bearing ring 87a (e.g., a polymer material) resting between the lip 88a and the top surface of the upper plate 66a. The upper ring 68a is attached to the lower portion 68b by the fasteners 69.

The hub 67 (e.g., the lower portion 68b, the upper ring 68a, the gear 79, the fasteners 69, the keys 85), the arm 71, the fastener 72, the contact member 82, and the spring 83 may be formed from steel, titanium, and/or other suitable materials. The structure of various herein-described features of the reaction bar 60 may be modified. Such modified structures may retain functionality described herein, but may have a different visual appearance. For example, shapes of the upper plate 66a, the lower plate 66b, the extension 63, and/or the outer portion 64 may be varied.

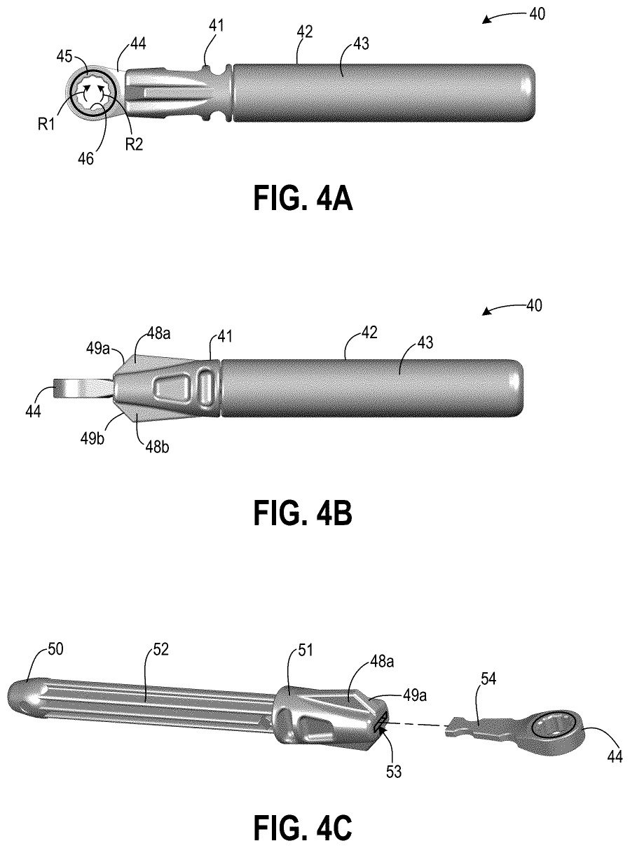

FIGS. 4A-4C show additional details of the wrench 40. FIG. 4A is a top view of the wrench 40. FIG. 4B is a side view of the wrench 40. Similar to the reaction bar shaft 62, the wrench shaft 42 comprises an overmolded plastic outer portion 43 and an inner portion described below. The shaft 42 may be cylindrical (e.g., may have a circular outer shape in a plane perpendicular to the lengthwise direction of the wrench). The wrench head 41 comprises a ratcheting box end wrench element 44 that may, except as described herein, be similar to known ratcheting box end wrenches. In particular, the wrench element 44 comprises a ring 45 that is rotatable within the element in a second rotational direction R2, but that is not rotatable within the element in a first rotational direction R1. An opening 46 in the ring 45 may be sized to receive the post 26 of the winding fork 20 and may have a profile that comprises a series of features configured to prevent the post 26, once inserted into the opening 46, from rotating within the opening 46 or relative to the ring 45.

The wrench head 41 may further comprise upper and lower ramps 48a and 48b. The ramp 48a may angle upward from a first location near the opening 46 to a second location that is further displaced from the opening 46. Similarly, the ramp 48b may angle downward from a third location near the opening 46 to a fourth location that is further displaced from the opening 46. The forward surface 49a of the ramp 48a may help prevent “scissoring” of the wrench shaft 41 and the reaction bar shaft 61. Specifically, the surface 49a is configured to contact the outer surface of the reaction bar shaft 61 to prevent the angle between the reaction bar shaft 61 and the wrench shaft 41, when the reaction bar 60 and the wrench 40 are installed on the winding fork 20, from decreasing below a minimum value. The minimum value may, for example, be between about 30 degrees and about 50 degrees (e.g., 30 degrees, 35 degrees, 40 degrees, 45 degrees, or 50 degrees). Moreover, the cylindrical shape of the reaction bar shaft 62 may prevent binding when the wrench 40 is placed into a position in which the surface 49a contacts the shaft 62. The forward surface 49b of the ramp 48b may similarly help maintain a minimum angle between the wrench 40 other objects near load restraint strip tails being tensioned. For example, load restraint strips may be used to secure cargo that has numerous surface shapes (e.g., pallet edges) other than the flat cargo unit rear faces shown in FIGS. 2A-2M, which shapes may likewise provide a potential scissoring effect if a minimum angle relative to the wrench 40 is not maintained.

FIG. 4C is an exploded perspective view showing the wrench element 44 and a frame 50 of the wrench 40. The frame 50 may be a monolithic single element formed from aluminum, steel and/or other suitable material. The frame 50 comprises a head main body portion 51 and an inner shaft portion 52 about which the plastic outer portion 43 is molded. An opening 53 in a front face of the main body portion 51 may receive a tang 54 of the wrench element 44. The tang 54 may be secured in the main body portion 51 by force fit of the tang 54 in the opening 53 and/or using adhesive. Individual components of the wrench element 44 may be formed from steel, titanium, and/or other materials.

The structure of various herein-described features of the wrench 40 may be modified. Such modified structures may retain functionality described herein, but may have a different visual appearance. For example, the lower ramp 48b may be omitted, shapes of the upper ramp 48a and/or the lower ramp 48b may be varied (e.g., forward surfaces 49a and/or 49b may be curved or truncated, and/or rear portions of either or both of the ramps may be truncated, elongated, and/or given a different shape), and/or a shape of the outer portion 43 may be varied.

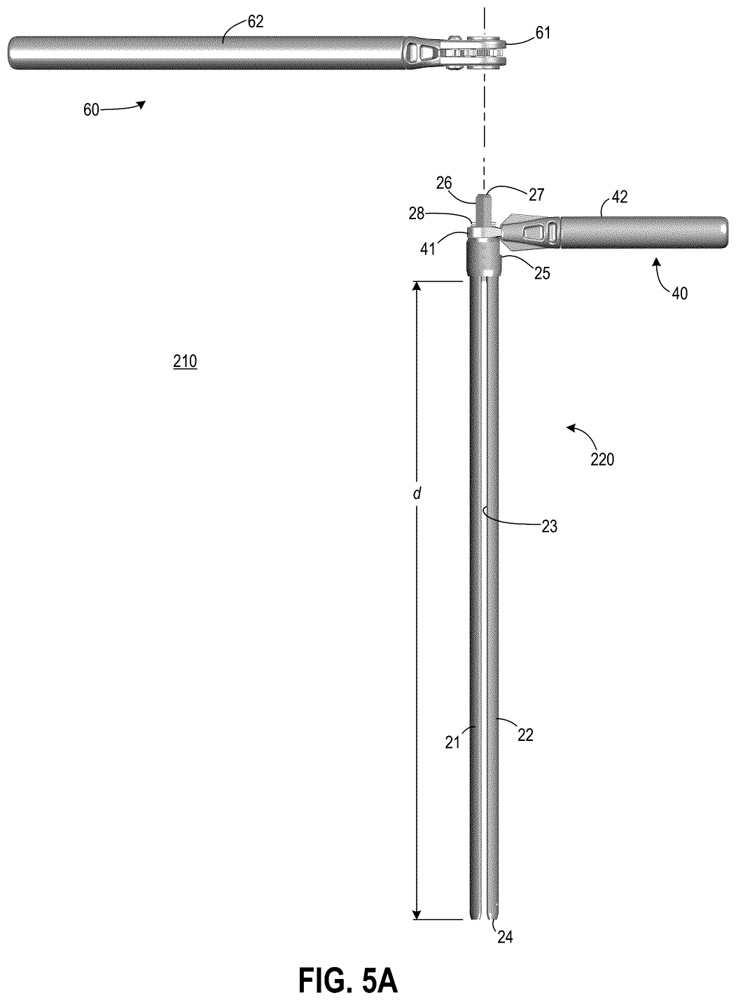

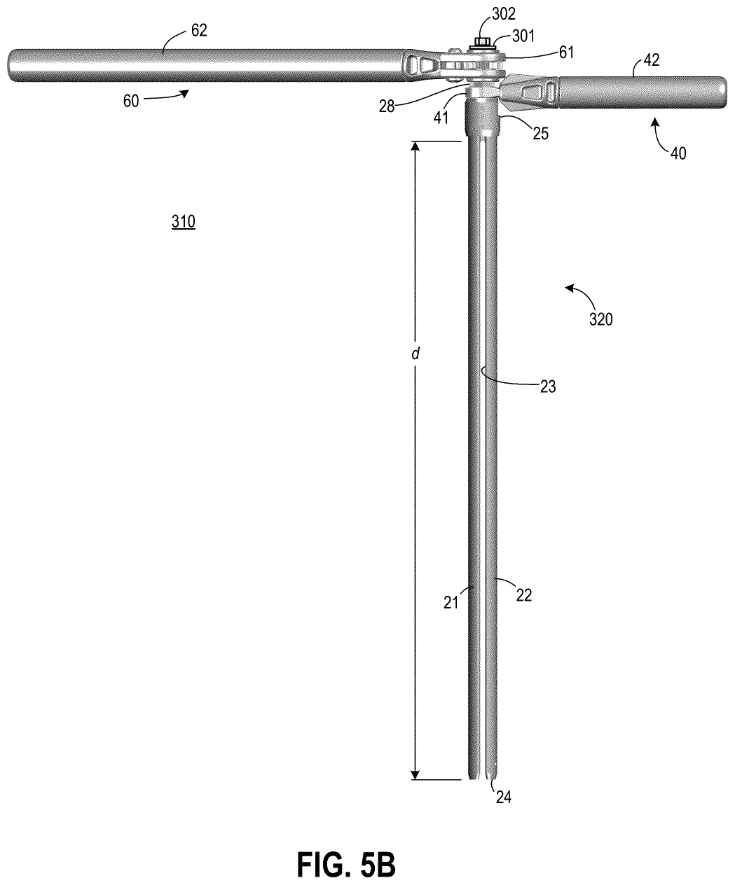

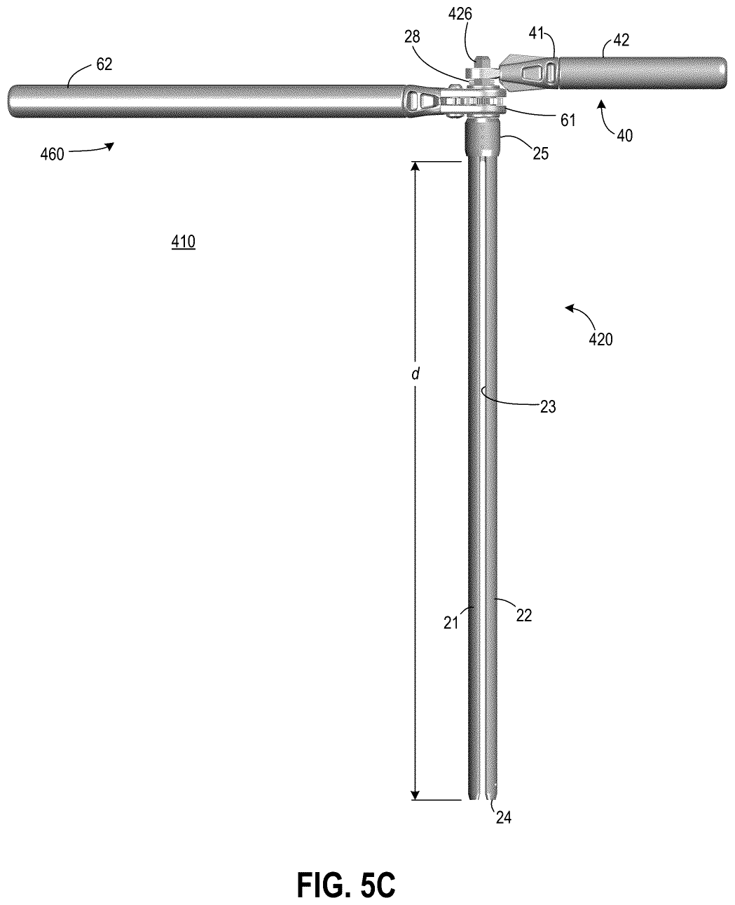

FIG. 5A shows an example of another tensioning tool 210. The tensioning tool 210 is similar to the tensioning tool 10 and comprises a winding fork 220, the wrench 40, and the reaction bar 60. The tensioning tool 210 differs from the tensioning tool 10 by virtue of the wrench 40 being fixed to the winding fork 220. In particular, after the wrench 40 has been placed onto the winding fork 220 by inserting the post 26 through the wrench head opening of the wrench 40, a spring pin 28 is inserted through the post 26. Although ratcheted rotation of ring 45 within the wrench element 44 is still possible, the wrench 40 is not removable from the winding fork 220 without first removing the pin 28. Other than the spring pin 28, the winding fork 220 may, for example, be the same as the winding fork 20. The configuration of the tensioning tool 210 may provide added convenience by keeping the wrench 40 and the winding fork 220 together as a unit, thereby reducing time to install load restraint strips. The tensioning tool 210 may be used in any of the methods described herein, but with the steps of placing a winding fork onto load restraint strip tails and installing a wrench onto the winding fork being replaced with a step of placing the winding fork 220 (with joined wrench 40) onto the tails, and with the steps of removing a wrench from the winding fork and removing the winding fork from the tails being replaced with a step of removing the winding fork 220 (with joined wrench 40) from the tails.

FIG. 5B shows an example of another tensioning tool 310. The tensioning tool 310 is similar to the tensioning tool 10 and the tensioning tool 210 and comprises a winding fork 320, the wrench 40, and the reaction bar 60. The tensioning tool 310 differs from the tensioning tool 210 by virtue of the reaction bar 60 also being fixed to the winding fork 320. In particular, after the wrench 40 has been attached the winding fork 320 as described above for the tensioning tool 210, and after the post 26 is inserted through the opening 70 of the hub 67, the reaction bar 60 may be fixed to the winding fork 320 using a bolt 302 and washer 301, with the bolt 302 screwed into a threaded opening in an upper end of the winding fork 320. After fixing the reaction bar 60 to the winding fork 320, the hub 67 is still rotatable within the openings in the plates 66a and 66b, but the reaction bar 60 is not removable from the winding fork 320 without first removing the bolt 302. Optionally, the spring pin 28 may be omitted from the tensioning tool 310. Other than the bolt 302, the washer 301, and the spring pin 28 (if present), the winding fork 320 may, for example, be the same as the winding fork 20. The configuration of the tensioning tool 310 may provide further added convenience by keeping the reaction bar 60, the wrench 40, and the winding fork 320 together as a unit, thereby reducing time to install load restraint strips. The tensioning tool 310 may be used in any of the methods described herein, but with the steps of placing a winding fork onto load restraint strip tails, installing a wrench onto the winding fork, and installing a reaction bar onto the winding fork being replaced with a step of placing the winding fork 320 (with joined wrench 40 and reaction bar 60) onto the tails, and with the steps of removing a reaction bar from a winding fork, removing a wrench from the winding fork, and removing the winding fork from the tails being replaced with a step of removing the winding fork 320 (with joined wrench 40 and reaction bar 60) from the tails.

FIG. 5C shows an example of another tensioning tool 410. In the tensioning tool 410, a reaction bar 460 is below the wrench 40, and the reaction bar 460 is fixed to the winding fork 420 by a pin 28 through a post 426 of the winding fork 420. An opening in a top of a hub of the reaction bar 460 is widened so that the post 426 may extend through that hub. Otherwise, the reaction bar 460 may be the same as the reaction bar 60. Except for the pin 28 and a slightly longer post 426, the winding fork 420 may be the same as the winding fork 20. A pin 28 may be included in the post 426 above the wrench 40 to also fix the wrench 40 to the winding fork 420. If a pin 28 is included above wrench 40, a pin 28 above the reaction bar 460 and below the wrench 40 may be omitted. The tensioning tool 410, or a tensioning tool similar to the tensioning tool 410 but with the wrench 40 also fixed to the winding fork 420, may be used in any of the methods described herein modified to omit and/or consolidate relevant steps. Such step omissions or consolidations are readily apparent in view of the disclosures herein.

A reaction bar such as (or similar to) the reaction bar 60 or the reaction bar 460, and/or a wrench such as (or similar to) the wrench 40, may be fixed to a winding fork such as (or similar to) any of the winding forks 20, 220, 320, or 420 using other structures (e.g., set screws, collars attached to a winding fork post, widened regions machined into a winding fork post, etc.) and/or techniques (e.g., forced press fit, spot welding, etc.).

Returning briefly to FIG. 2M, the patch 121 has a width that is approximately the same as the widths of the load restraint strips 104a and 104b. In some respects, this arrangement is beneficial, as it helps prevent adhesive from the patch 121 contacting the cargo secured by load restraint strips to which the patch has been attached. In other respects, however, this arrangement can have disadvantages. For example, during shipping, cargo within a container may shift. Such shifting can result in a loss of tension in the load restraint strips (e.g., if cargo shifts forward), potentially allowing the load restraint strips to drop down. This may be exacerbated if the load restraint strips were not properly tensioned.

FIG. 6A shows a first face 631 of an patch 621 comprising features to help reduce the above-described problems associated with shifting cargo. The patch 621 may have a width W1 that is greater than a width of load restraint strips to which the patch may be attached. As described below, this allows portions of the patch 621 above and below those load restraint strips to be adhered to cargo, thereby helping to keep those load restraint strips in position if the cargo shifts.

The first face 631 may, when the patch 621 is attached to load restraint strips, be positioned to face away from those load restraint strips. Various types of indicia may be printed on the first face 631. The indicia may comprise lines 632a and 632b. A width W2 between the lines 632a and 632b may correspond to a width of the load restraint strips to which the patch 621 is to be attached. The lines 632a and 632b may thus be used as guides to help position the patch 621 during attachment to those load restraint strips. The indicia may further comprise instructions 633 placed at multiple locations along the lines 632a and 632b. The instructions 633 may, for example, instruct workers that the lines 632a and 632b are to be aligned with upper and lower edges of the load restraint strips to which the patch 621 is being attached.

FIG. 6B shows a second face 635 of the patch 631. The second face 635 may comprise a plurality of release liners 636, 637a, and 637b. The release liners may, prior to attaching of the patch to load restraint strips, cover an adhesive 639 of the load restraint strip. For purposes of explanation, the release liners 636, 637a, and 637b are shown partially peeled away in FIG. 6B. However, the release liners 637a and 637b may not be peeled away until after the patch 621 is partially attached. For example, when preparing to attach the patch 621, the release liner 636 may be removed to expose a central portion 641 of the adhesive 639 that comprises reinforcement strands 652 (described below). However, the liner 637a may be left in place to cover a first lateral portion 642a of the adhesive 639, and the liner 637b may be left in place to cover a second lateral portion 642b of the adhesive 639. The patch 621 may then be attached to tensioned load restraint strip tails by pressing the exposed central portion 641 of the adhesive 639 into contact with the tails. As mentioned above, the lines 632a and 632b, if present, may be used to position the patch 621.

FIG. 6C shows the patch 621 after attaching to the tensioned load restraint tails 106a and 106b. The example of FIG. 6C assumes that the patch 221 is used instead of the patch 121 shown in FIGS. 2J and 2M. For purposes of explanation, upper and lower portions of the patch 621 (comprising the first lateral portion 642a covered by the liner 637a and the second lateral portion 642b covered by the liner 637b) are shown folded over, though such folding over need not be performed. Because the liners 637a and 637b were left in place, adhesive 639 in the first lateral portion 642a and in the second lateral portion 642b does not interfere removal of the tensioning tool 10 or adhere to a worker removing the tensioning tool 10. After the tensioning tool 10 is removed, and as shown in FIG. 6D, the liners 637a and 637b may be removed, the adhesive 639 in the first lateral region 642a may be pressed into contact with structures above the tails 106a and 106b (portions of the secured cargo units 101a, 101b and 101c in the example of FIG. 6D), and the adhesive 639 in the second lateral region 642b may be pressed into contact with structures below the tails 106a and 106b (other portions of the secured cargo units 101a, 101b and 101c in the example of FIG. 6D).

FIG. 6E is a partially schematic truncated cross-sectional view of the patch 621 taken from the location indicated in FIG. 6B and rotated 90 degrees. FIG. 6E shows elements of the patch in a lined configuration with release liners 636, 637a, and 637b in place. The bold, curved truncation lines at the sides of FIG. 6E indicate that the structure immediately adjacent to those side truncation lines may extend to the edges of the patch 221. The bold, curved truncation lines in the center of FIG. 6E indicate that the structure immediately adjacent to those center truncation lines may extend throughout the omitted portion of the patch 621 between those center truncation lines.

The patch 621 may comprise a base layer 651 and reinforcement strands 652. The reinforcement strands may be secured to the liner 651 by the adhesive 639. The reinforcement strands may be absent from the first lateral portion 642a and the second lateral portion 642b and only present in the central portion 641. The release liners 637b, 636, and 637a may be removably adhered to the adhesive 639. The base layer may comprise a nonwoven fabric. Nonwoven fabrics may, for example, comprise spun-bonded polymer fiber materials (e.g., a spun bonded polyethylene fiber mat), felted fiber mats, and/or other materials that comprise webs/mats of fibers that have not been woven, and that have been bonded chemically, bonded using heat or other treatment, and/or bonded mechanically. Mechanical bonding may comprise needle punching (e.g., felting), hydro entanglement, and/or stitch bonding. In the example of the patch 621, the base layer 651 comprises a nonwoven fabric band of a stitchbond fabric. Also or alternatively, the base layer may comprise a monolithic polymer film, paper, or other material. Any of the materials described as load restraint strip base layer materials in any of the previously incorporated patents or patent application may be used for the base layer 651.

The reinforcement strands 652 may comprise one or more polymer fibers and may, for example, comprise any the polymer fibers or other materials (e.g., glass fibers, carbon fibers) described in any of the previously incorporated patents or patent application as usable for load restraint strip reinforcement fibers. Optionally, the reinforcement strands 652 may be omitted (e.g., if the base layer is a monolithic polymer film). The adhesive 639 may comprise a pressure sensitive adhesive (PSA) such as an acrylic PSA. The release liners 637b, 636, and 637a may, for example, be formed from a paper or polymer product that is treated (e.g., coated or otherwise impregnated with wax, silicone or other non-stick material) to resist the adhesive 639.

The patch 621, and/or other patches described herein, may also be used with load restraint strips in other configurations. For example, FIG. 6F shows an example use of the patch 621 in conjunction with a bulkhead 699. The bulkhead 699 may be placed behind loaded cargo units, and tails 106a and 106b of the load restraint strips 104a and 104b (for which the adhesive 105a and 105b may have been attached to the interior sides of the walls 107L and 107R prior to loading some or all of the cargo units) wrapped around a rear side of the bulkhead 699. The procedure for use of the patch 621 in the example of FIG. 6F may be similar to that described above in connection with FIGS. 6C and 6D. In the example of FIG. 6F, the structure above and below the tails 106a and 106b to which the adhesive 639 in the first lateral portion 642a and in the second lateral portion 642b may be attached is the bulkhead 699 instead of surfaces of loaded cargo units. The bulkhead 699 may, for example, be a bulkhead as described in U.S. patent application Ser. No. 18/533,578, titled “Dual Mode Cargo Restraint” and filed Dec. 8, 2023, which application in its entirety is incorporated by reference herein. Also or alternatively, the patch 621, and/or other patches described herein, may be used in conjunction with load restraint strips in any of the configurations described in U.S. patent application Ser. No. 17/851,280, titled “Dual Mode Cargo Restraint” and filed Jun. 28, 2022, which application in its entirety is incorporated by reference herein.

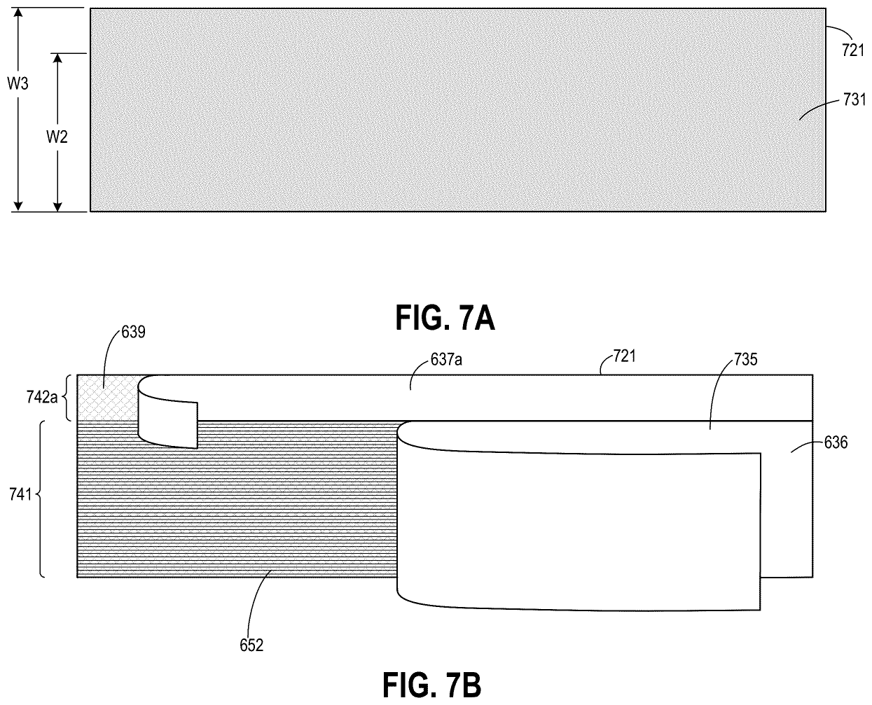

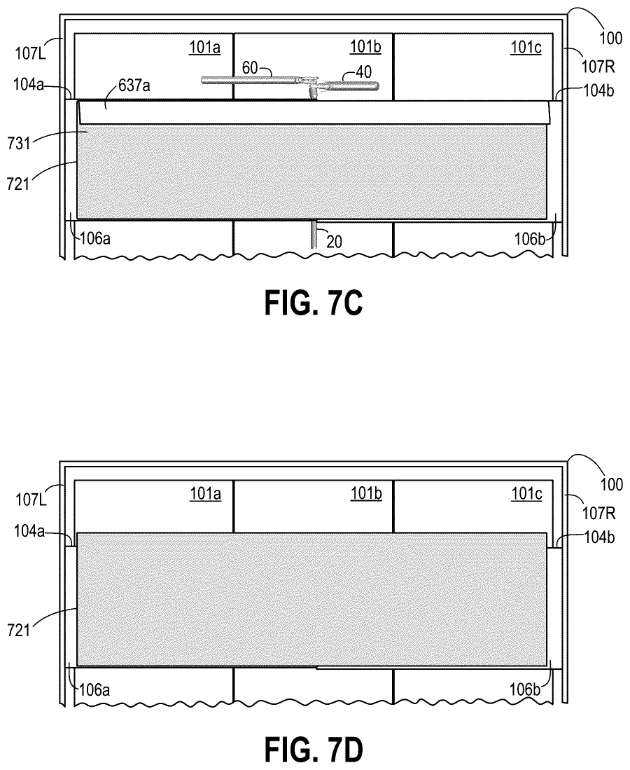

FIG. 7A shows a first face 731 of another example patch 721. FIG. 7B shows a second face 735 of the patch 721. The patch 721 may be similar to the patch 621, but with a second lateral portion (similar to the second lateral portion 642b of the patch 621) being omitted, and with the patch 721 thus having width W3 less than the width W2. Central portion 741 and first lateral portion 742a may be the same as the central portion 641 and the first lateral portion 642a of the patch 621. As shown in FIGS. 7C and 7D, the patch 721 may be used in a manner similar to that described in connection with the patch 621, but with a lower edge of the patch 721 aligned with lower edges of the tails 106a and 106b. Because the lower edge of the patch 721 is usable as a guide for attaching the patch 721, indicia may be omitted from the first face 731. Alternatively, some or all of the indicia shown in FIG. 6A (and/or other indicia) may be included on the first face 731.

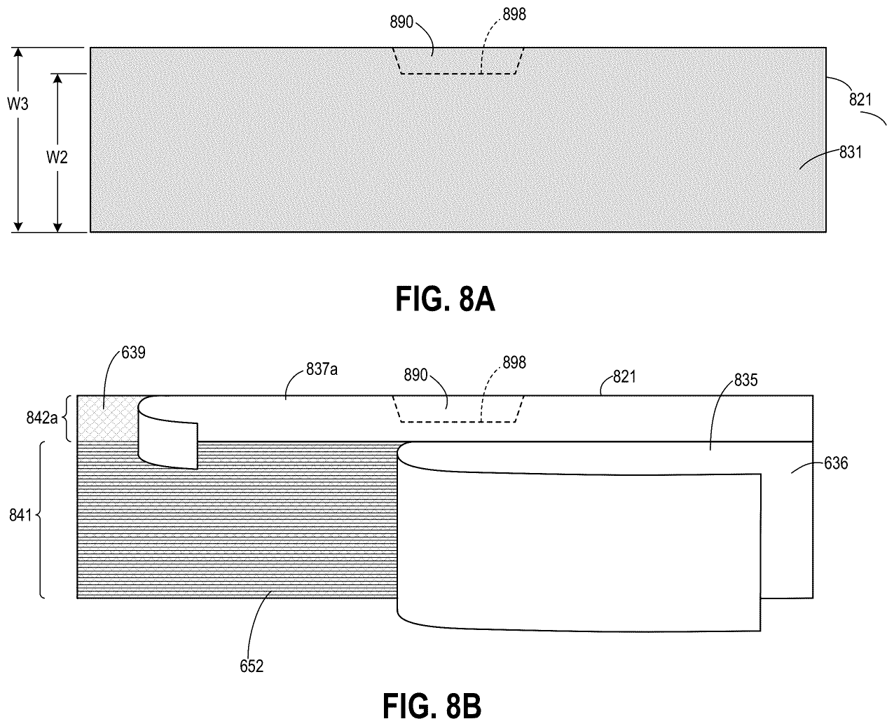

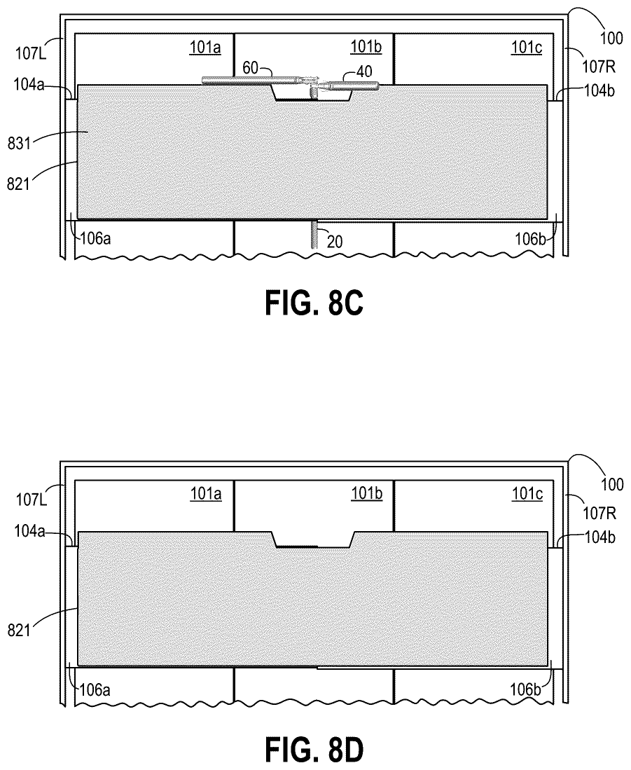

FIG. 8A shows a first face 831 of another example patch 821. FIG. 8B shows a second face 835 of the patch 821. The patch 821 may be similar to the patch 721, but with a cut-out region 890 defined by perforations 898. Central portion 841 may be the same as the central portion 741 of the patch 721. Except for the perforations 890, the first lateral portion 842a may be the same as the first lateral portion 742a of the patch 721. The perforations 898 may extend through the base layer of the patch 821 and through the release liner 837a, with the release liner 837a otherwise being the same as the release liner 637a. As shown in FIGS. 8C and 8D, the patch 821 may be used in a manner similar to that described in connection with the patch 621, but with a lower edge of the patch 821 aligned with lower edges of the tails 106a and 106b, and with the cutout 890 removed (e.g., prior to attachment of the patch 821 to the tails 106a and 106b, and by tearing along the perforations 898) to avoid interference with the tensioning tool 10. Because the lower edge of the patch 821 is usable as a guide for attaching the patch 821, indicia may be omitted from the first face 831. Alternatively, some or all of the indicia shown in FIG. 6A (and/or other indicia) may be included on the first face 831. Instead of separate release liners 636 and 837a, the patch 821 may have a single release liner covering both the central portion 841 and the first lateral portion 842a and having perforations 898.

The foregoing has been presented for purposes of example. The foregoing is not intended to be exhaustive or to limit features to the precise form disclosed. The examples discussed herein were chosen and described in order to explain principles and the nature of various examples and their practical application to enable one skilled in the art to use these and other implementations with various modifications as are suited to the particular use contemplated. The scope of this disclosure encompasses, but is not limited to, any and all combinations, subcombinations, and permutations of structure, operations, and/or other features described herein and in the accompanying drawing figures.

1. A tensioning tool, for use in securing load restraint strips, comprising:
a wrench comprising a ratcheting box end wrench head coupled to a wrench shaft, the wrench head further comprising a wrench head opening;
a reaction bar comprising a reaction bar head coupled to a reaction bar shaft, the reaction bar head further comprising a rotatably mounted hub, an arm, and a movable contact member biased into position against an edge of the arm forming a cam surface, wherein:
the rotatably mounted hub comprises a gear and a hub opening,
the arm comprises a pawl configured to engage the gear when the arm is in a first position,
the cam surface is configured so that, when the arm is in the first position, force of the contact member against a first portion of the cam surface biases the pawl against the gear to prevent rotation of the hub within the reaction bar head in a first of two rotational directions, and
the cam surface is configured so that, when the arm is in a second position, force of the contact member against a second portion of the cam surface holds the pawl away from the gear to allow rotation of the hub within the reaction bar head in the first of the two rotational directions and to allow rotation of the hub within the reaction bar head in a second of the two rotational directions; and
a winding fork comprising upper and lower ends and a slot that extends upward from the lower end to define a pair of tines for receiving overlapped tails of load restraint strips, wherein the upper end comprises a post having a size and shape configured to be gripped by the wrench head opening, to be gripped by the hub opening, and to simultaneously extend through the wrench head opening and into the hub opening.

2. The tensioning tool of claim 1, the wrench comprising a ramp on an upper side of the wrench, wherein an edge of the ramp angles upward from first location near the wrench head opening to a second location displaced from the wrench head opening.

3. The tensioning tool of claim 2, wherein the ramp is sized to prevent, when the post is inserted into the wrench head opening and the hub opening, an angle of less than 45 degrees between the wrench shaft and the reaction bar shaft.

4. The tensioning tool of claim 1, the arm further comprising a switch extension that protrudes from a side of a housing of the reaction bar head and that is movable in a first direction to move the arm from the first position to the second position and that is movable in a second direction to move the arm from the second position to the first position.

5. The tensioning tool of claim 1, wherein the slot extends upward to define a slot depth of at least 24 inches.

6. The tensioning tool of claim 1, wherein the reaction bar shaft comprises an overmolded plastic having a cylindrical outer surface.

7. The tensioning tool of claim 1, wherein the tines are hollow.

8. The tensioning tool of claim 1, wherein the wrench is fixed to the post.

9. A method of securing cargo in a cargo container, the method comprising:
affixing attachment regions of first and second load restraint strips to interior walls of a cargo container;
loading cargo in the cargo container;
wrapping tails of the first and second load restraint strips across the loaded cargo;
placing a winding fork of a tensioning tool on overlapped ends of the wrapped tails;
tensioning the wrapped tails by rotating a wrench of the tensioning tool, while a reaction bar of the tensioning tool remains stationary, to wind portions of the tails around the winding fork;
attaching, while movement of the reaction bar prevented by the loaded cargo, an adhesive backed patch to the tensioned tails;
after attaching the patch, releasing a ratchet of the reaction bar by applying a force to move an extension on the reaction bar from a first position to a second position, wherein the ratchet remains released after application of the force is complete;
rotating a reaction bar shaft of the reaction bar away from the loaded cargo; and
after rotating the reaction bar shaft away from the loaded cargo, removing the winding fork from the tails.

10. The method of claim 9, wherein attaching the patch comprises applying adhesive in a central portion of patch to the tensioned tails, the method further comprising:
applying adhesive in a first lateral portion of the patch to a structure above the tensioned tails.

11. The method of claim 10, wherein the structure comprises one of a portion of the cargo or a bulkhead placed behind the cargo.

12. The method of claim 10, further comprising:
removing, prior to applying the adhesive in the central portion of the patch to the tensioned tails, a central release liner from the central portion; and
removing, prior to applying the adhesive in the first lateral portion of the patch to the structure above the tensioned tails, and after applying the adhesive in the central portion of patch to the tensioned tails, a first lateral release liner from the first lateral portion.

13. The method of claim 10, further comprising:
removing, prior to applying the adhesive in the first lateral portion of the patch to the structure above the tensioned tails, a cutout portion defined by perforations in the patch.

14. The method of claim 10, wherein the patch comprises reinforcing fibers in the central portion of the patch and lacks reinforcing fibers in the first lateral portion of the patch.

15. The method of claim 9, wherein placing the winding fork on the overlapped ends comprises placing the winding fork with the wrench attached to the winding fork.

16. The method of claim 9, wherein:
a head of the reaction bar comprises an arm and a movable contact member that is biased against a first portion of an edge of the arm,
the reaction bar head further comprises a hub having an opening for receiving a portion of an end of the winding fork,
the arm comprises the extension and a pawl configured to engage a gear of the hub when the extension in the first position,
the first portion of the edge of the arm is configured so that, when the extension is in the first position, force of the contact member against the first portion biases the pawl against the gear to prevent rotation of the hub within the head of the reaction bar in a first of two rotational directions, and
a second portion of the edge of the arm is configured so that, when the extension is in the second position, force of the contact member against the second portion holds the pawl away from the gear.

17. The method of claim 9, wherein each of the tails has a width of at least 24 inches, and wherein placing the winding fork on the overlapped ends of the wrapped tails comprises placing the winding fork so that an entire width of each of the tails is contained in a slot of the winding fork.

18. A method of securing cargo in a cargo container, the method comprising:
affixing attachment regions of first and second load restraint strips to interior walls of a cargo container;
loading cargo in the cargo container;
wrapping tails of the first and second load restraint strips across the loaded cargo;
placing a winding fork of a tensioning tool on overlapped ends of the wrapped tails;
tensioning the wrapped tails by rotating a wrench of the tensioning tool, while a reaction bar of the tensioning tool remains stationary, to wind portions of the tails around the winding fork;
after removing a central release liner from a central portion of an adhesive-backed a patch, applying adhesive in the central portion to the tensioned tails;
after applying the adhesive in the central portion of the patch, removing the winding fork from the tails; and
after applying the adhesive in the central portion of the patch, and after removing a first lateral release liner from a first lateral portion of the patch, applying adhesive in the first lateral portion to a structure above the tensioned tails.

19. The method of claim 18, wherein the central portion comprises reinforcing fibers and the first lateral portion lacks reinforcing fibers.

20. The method of claim 18, wherein:
a head of the reaction bar comprises an arm and a movable contact member that is biased against a first portion of an edge of the arm,
the reaction bar head further comprises a hub having an opening for receiving a portion of an end of the winding fork,
the arm comprises a pawl configured to engage a gear of the hub when the arm is in a first position,
the first portion of the edge of the arm is configured so that, when the arm is in the first position, force of the contact member against the first portion biases the pawl against the gear to prevent rotation of the hub within the head of the reaction bar in a first of two rotational directions, and
a second portion of the edge of the arm is configured so that, when the arm is in a second position, force of the contact member against the second portion holds the pawl away from the gear.
